(19) United States
(12) Patent Application Publication
(10) Pub. No.: US 2007/0031014 A1
(43) Pub. Date: Feb. 8, 2007

(54) Method and device for aligning of a fingerprint

(75) Inventors: Fredrik Soderberg, Lund (SE); Magnus Wennergren, Lund (SE); Bjorn Nordin, Lund (SE)

Correspondence Address: BIRCH STEWART KOLASCH & BIRCH, PO BOX 747, FALLS CHURCH, VA, 22040-0747, US

(73) Assignee: PRECISE BIOMETRICS AB

(21) Appl. No.: 11/498,160

(22) Filed: Aug. 3, 2006

Related U.S. Application Data
(60) Provisional application No. 60/704,893, filed on Aug. 3, 2005.

(30) Foreign Application Priority Data
Aug. 3, 2005 (SE) 0501763-7

(51) Int. Cl. G06K 9/00

(52) U.S. Cl. 382/125

(57) ABSTRACT

The present invention relates to methods for aligning an input fingerprint with a reference fingerprint, methods for comparing an input fingerprint with a reference fingerprint, computer program products for aligning an input fingerprint with a reference fingerprint, computer program products for comparing an input fingerprint with a reference fingerprint, devices and systems for aligning an input fingerprint with a reference fingerprint, and devices and systems for comparing an input fingerprint with a reference fingerprint.

### FIELD OF THE INVENTION

The present invention relates to methods for aligning an input fingerprint with a reference fingerprint, methods for comparing an input fingerprint with a reference fingerprint, computer program products for aligning an input fingerprint with a reference fingerprint, computer program products for comparing an input fingerprint with a reference fingerprint, devices and systems for aligning an input fingerprint with a reference fingerprint and also devices and systems for comparing an input fingerprint with a reference fingerprint.

### BACKGROUND ART

There are many situations in modern society where the identity of a person is verified. One example of such a situation is a card payment. In a card payment, it is in fact necessary for a card holder to verify somehow that he is the rightful holder of the card and thus has not laid hands on the card in a dishonest way. One example of such a way is that the card holder indicates a pin code which is connected to the card in order to verify that he is the rightful user.

There are also situations in modern society where a person is identified. One example of such a situation is an access control system in a company. This system should be able to identify employees of the company, after which identified employees are admitted while non-employees are not admitted. To achieve this, each employee can have a plastic card with a stored unique access identity. In order to be admitted, the employee lets the system read the stored access identity. This read access identity is then compared in the system with a number of reference access identities. If the employee's access identity is included in this number of reference access identities, the employee will be admitted, but if not, the employee will not be admitted.

The difference between the two above-described situations, verification and identification, is that in the first case, it is a matter of comparing two data sets to be able to establish whether they are identical or not, while in the second case it is a matter of comparing a specific data set with a number of data sets to be able to establish whether this specific data set is identical to one of said number of data sets.

To be able to offer safer verification and identification situations, various methods have been developed. One of the methods for this purpose is recognition of fingerprints.

The reason why fingerprints are well suited for identification and verification is that the structure of papillary lines on the fingertips varies for different people.

In prior-art technique for recognizing fingerprints, there are a number of different comparing methods to be able to establish whether there is a match between two fingerprints. In many cases, this match involves comparing an input fingerprint with a stored reference fingerprint. In the case of verification, only one comparison occurs, whereas in the case of identification a number of comparisons occur.

One way of making this comparison is to match points in the fingerprints. These points frequently consist of the endings and bifurcations of the papillary lines and are often referred to as minutiae points.

To ensure a safe system, it is important for the reference fingerprint not to fall into the wrong hands. A good solution to this is to have the reference fingerprint stored on a smart card, that is a card with storage and calculating capacity. When a fingerprint has been read by a fingerprint reader, this is transferred to the smart card. Once in the smart card, the input fingerprint is compared with the stored reference fingerprint.

Since each user should have a smart card of his own, it is desirable for the reference fingerprint to contain a small data set since this means that a smaller and less expensive memory can be used. A small data set also means that the transfer time between reader and card and also the power consumption can be reduced.

Similarly, it is desirable to have a comparison algorithm which uses few processor clock cycles since this means that the comparison will be quicker, or alternatively to use a processor with a lower working frequency.

One way of reducing the data set is to store, for each minutiae point, only a position indicating where in the fingerprint the minutiae point is positioned, an angle indicating the direction of the papillary line in the current minutiae point, and a type indicating whether the current minutiae point is a bifurcation or an ending. Since only this data reaches the smart card, the reference fingerprint can be stored correspondingly.

When comparing the input fingerprint with the reference fingerprint, in many cases first an alignment occurs. An alignment means broadly that the input fingerprint and the reference fingerprint are adjusted so that they can both be expressed with the same coordinates.

Problems may arise in alignment, and thus also in comparison, if the person whose finger is to be read presses his finger against the reader more firmly or less firmly on different occasions. In particular, it is inconvenient if the person presses his finger more firmly or less firmly when inputting the reference fingerprint and in other inputs.

In the same way, it will be inconvenient if the person rotates his finger differently on different occasions of reading, or places his finger differently on different occasions of reading.

Thus, the point is to create a fast and reliable method of comparing an input fingerprint with a reference fingerprint, taking into consideration that the input fingerprint can be rotated or placed differently from one time to the next, and that the person whose fingerprint is input can press his finger more firmly or less firmly against the reader from one time to the next.

A known solution to this is to transfer the coordinates for the minutiae points in the input fingerprint to the smart card. After that one of the minutiae points is selected to be a reference point. Based on this reference point, the distances to the other minutiae points are calculated. For this solution to function, corresponding reference points must be used in the input fingerprint and the reference fingerprint, which can be a problem since this only reference point can be difficult to identify.

Another known solution is disclosed in Swedish Patent Application No. 0300478-5. This document describes a solution where the minutiae points are paired in groups of two. Subsequently the distance between the points in the group and the relative angles of these points are calculated. An advantage of this solution is that no reference point has to be determined. However, it may be disadvantageous that, if several groups of minutiae points are missing, for instance because the input fingerprint has been slightly moved compared with the reference fingerprint, the assessment of the resemblance between the fingerprints is affected since all groups of minutiae points must be assessed as a unit, which results in a lower separability between different fingerprints.

### SUMMARY OF THE INVENTION

An object of the present invention is to wholly or partly eliminate the problems associated with prior art. Other objects will be evident from the following description.

The object is achieved wholly or partly by a method, a computer program product, a device or a system according to the independent claims. Embodiments of the invention are defined in the dependent claims and in the following description.

The expression “a first coordinate” is to be understood as a number which expresses the location of the point in a first direction, and correspondingly the expression “a second coordinate” is to be understood as a number that expresses the location of the point in a second direction.

Moreover, expressions such as “rotating a fingerprint” or “translating a fingerprint” should also comprise rotating or translating data that is associated with the fingerprint in question. Examples of data that is associated with the fingerprint can be coordinate data for points in the fingerprint.

According to a first aspect, a method is provided of aligning an input fingerprint with a reference fingerprint, comprising determining and compensating for a rotational difference by means of a number of reference angles based on said reference fingerprint and corresponding angles of said input fingerprint.

The method may comprise identifying a number of points in said input fingerprint, forming groups of said number of points, and determining an angle for each said group to constitute an angle of said input fingerprint.

The method may comprise forming a number of angle differences by subtracting each of said angles with each of said reference angles, determining a number of occurrences of angle differences in a number of angle ranges, and determining a main angle range.

The method may comprise compensating for said rotational difference by rotating said input fingerprint at an angle based on said main angle range.

An advantage of this aspect is that a relatively large set of data can be obtained from a relatively small number of points, which results in a better basis for assessing the rotational distance between the two fingerprints.

In one of the embodiments of the invention, the main angle range is the angle range in which the number of occurrences of angle differences is greatest.

In another embodiment of the invention, the main angle range is only searched in a predetermined angle window.

An advantage of this embodiment is that a smaller storage is required.

Another advantage of this embodiment is that the predetermined angle window can be adjusted to the construction of a fingerprint reader. For example, if only a certain angle window is possible, for instance due to the construction of the fingerprint reader, adjustments can be made so that only this angle window is taken into consideration.

In a further embodiment, the present invention additionally comprises interrupting the alignment if said number of occurrences in said main angle range is smaller than a first predetermined minimum of occurrences.

The advantage of this embodiment is that a weak correspondence between the input fingerprint and the reference fingerprint is discovered early in the comparison process, which saves time and unnecessary calculations.

Another embodiment further comprises sending a first result signal to a device.

This means that the system can more quickly signal to the person whose identity is to be verified or identified that a new fingerprint must be input.

The above embodiments further comprise determining and compensating for a first translational difference in a first direction by means of a number of first reference coordinates based on said reference fingerprint and corresponding coordinates of said input fingerprint.

The method may comprise determining a first coordinate for each said group of points in said input fingerprint.

The method may comprise forming a number of first coordinate differences by subtracting each of said first coordinates with each of said first reference coordinates, determining a first number of occurrences of coordinate differences in a number of first ranges, and determining a first main range.

The method may comprise compensating for said first coordinate difference by translating said input fingerprint a distance based on said first main range in said first direction.

According to another embodiment of the invention, said first main range may be the first range in which the number of occurrences of first coordinate references is greatest.

In another embodiment of the invention, said first main range is only searched in a first predetermined translation window.

An advantage of this embodiment is that a smaller storage is required.

Another embodiment of the invention further comprises interrupting the alignment if said first number of occurrences in said first main range is smaller than a second predetermined minimum of occurrences.

An advantage of having several checks between different steps in the alignment process is that these checks can gradually be made more stringent further on in the alignment process.

A further advantage of this is that it is possible to adjust said first and said second predetermined minimum of occurrences to a special type of fingerprint reader.

In another embodiment, the present invention may further comprise sending a second result signal to a device.

An advantage is here that it is possible to keep statistics of whether the alignment process was stopped at the rotation compensation stage or at the first translation stage by different signals being sent in case of stoppage at these two different stages.

Another embodiment of the present invention may further comprise determining and compensating for a second translational difference in a second direction by means of a number of second reference coordinates based on said reference fingerprint and corresponding coordinates of said input fingerprint.

The method may comprise determining a second coordinate for each said group of points in said input fingerprint.

The method may comprise forming a number of second coordinate differences by subtracting each of said second coordinates with each of said second reference coordinates, determining a number of second occurrences of coordinate differences in a second number of ranges, and determining a second main range.

The method may comprise compensating for said second coordinate difference by translating said input fingerprint a distance based on said second main range in said second direction.

An advantage of this embodiment is that the two coordinates in the input fingerprint and the reference fingerprint are synchronized, which means that the points in the input fingerprint have corresponding points in the reference fingerprint with the same coordinates, which means that a further comparison between them is facilitated.

In another embodiment of the present invention, said second main range can be the range in which the number of occurrences of second coordinate references is greatest.

In another embodiment of the invention, said second main range is only searched in a second predetermined translation window.

An advantage of this embodiment is that a smaller storage is required.

Another embodiment further comprises interrupting the alignment if said number of second occurrences in said second main range is smaller than a third predetermined minimum of occurrences.

An advantage of this embodiment is that it is possible to adjust the first, the second and the third predetermined minimum of occurrences to a special type of fingerprint reader.

According to another embodiment, the present invention may further comprise sending a third result signal to a device.

An advantage is here that it is possible to keep statistics of whether the alignment process was stopped at the rotation compensation stage, the first translation stage or the second translation stage by different signals being sent in case of stoppage at these difference stages.

In another embodiment of the invention, said points are minutiae points.

An advantage of this that there are well developed methods of finding minutiae points.

Said points can also be other points in the fingerprints which differ from the remaining points. For instance, said points can have characteristic Fourier transform or some other type of spectral data.

Another embodiment of the present invention comprises the feature that said group consists of two points.

An advantage of this is that a smaller number of operations are required to calculate the angle and the two coordinates for the group.

In another embodiment of the invention, only groups are formed of points which are associated with a quality measure which is greater than a predetermined quality threshold.

An advantage of this embodiment is that only points of a certain quality are included in the alignment, which makes it more reliable and quicker since the number of points is reduced.

A further embodiment comprises the feature that only groups are formed of points which are positioned a greater distance from each other than a predetermined minimum distance.

An advantage of this is that points which are very close to each other are not taken into consideration since the relative faults that arise in calculations of an angle and a first and a second coordinate will be greater in the cases where the group consists of points which are very close to each other. A reason why the relative faults will be greater is that the points are placed in a digital image or, if desirable, a discrete two-dimensional data set, which means that there will be a minimum distance over which the points can be moved.

Another embodiment comprises the feature that only groups are formed of points which are positioned a smaller distance from each other than a predetermined maximum distance.

An advantage of this is that points which are positioned very far from each other are not taken into consideration since the groups of points which are positioned far from each other are more affected by the finger being pressed more firmly or less firmly against the fingerprint reader.

Another advantage of this embodiment is that the risk that one of the points in a group is positioned outside the image decreases.

Another embodiment comprises the feature that said determination of number of occurrences comprises calculating a difference between a distance associated with one of said groups in said input fingerprint and a distance associated with one of corresponding groups in said reference fingerprint.

An advantage of this is that the distance associated with one of said groups in said input fingerprint is invariant, that is not dependent on rotation and translation. As a result, this distance is the same independently of how the user's finger is placed on the fingerprint reader.

Another embodiment comprises the feature that said determination of number of occurrences comprises calculating a difference between a first angle associated with one of said groups in said input fingerprint and a first angle associated with one of corresponding groups in said reference fingerprint.

The advantage of this embodiment is that, just like the one above, it is invariant relative to the group. Said first angle can be a minutiae angle for one of the points, that is an angle which depends on the direction of the papillary lines in that point.

A further embodiment comprises the feature that said determination of number of occurrences comprises calculating a difference between a second angle associated with one of said groups in said input fingerprint and a second angle associated with one of corresponding groups in said reference fingerprint.

This embodiment is, just like the one above, invariant. Said second angle can be another minutiae angle.

A further embodiment comprises the feature that said determination of number of occurrences comprises calculating a difference between a type associated with one of said points in said input fingerprint and a type associated with one of corresponding points in said reference fingerprint.

This embodiment is, like the one above, invariant.

A further embodiment comprises the feature that said number of occurrences is incremented if at least one of said differences is smaller than a difference threshold value.

An advantage of this embodiment is that the rotation and translation compensation is to a greater extent based on relevant data.

Yet another embodiment comprises the feature that said number of occurrences is weighted with respect to at least one of said differences.

Another embodiment of the invention further comprises the feature of forming a number of comparison pairs by matching each said point in said input fingerprint with a corresponding point among said reference fingerprints.

An advantage of this embodiment is that the points in the input fingerprint which in the alignment phase form groups with each other, in this step form pairs with corresponding points in the reference fingerprint. By first aligning the input fingerprint with the reference fingerprint by comparing groups in the two fingerprints and, after that, aligning the input fingerprint with the reference fingerprint by comparing individual points in the two fingerprints, first a rough alignment and then a fine alignment are made, which results in effective alignment.

Another embodiment further comprises the feature of determining a first translational difference for each comparison pair in a first direction, calculating a first translation value for said first translational differences, and adjusting said input fingerprint relative to said reference fingerprint in a first direction according to said first translation value.

Another embodiment further comprises the feature of determining a first variation measure for said first translational differences, said adjustment taking place only if said first variation measure is lower than a first predetermined variation threshold.

An advantage of this embodiment is that if the first translational differences vary greatly, no adjustment is made in the first direction.

A further embodiment further comprises the steps of determining a second translational difference for each comparison pair in a second direction, calculating a second translation value for said second translational differences, and adjusting said input fingerprint relative to said reference fingerprint in a second direction according to said second translation value.

Another embodiment further comprises the feature of determining a second variation measure for said second translational differences, said adjustment taking place only if said second variation measure is lower than a second predetermined variation threshold.

An advantage of this embodiment is that if the second translational differences vary greatly, no adjustment is made in the second direction.

A further embodiment of the invention further comprises the features of forming a number of comparison pairs as stated above, and comparing said aligned input fingerprint with said reference fingerprint.

Another embodiment of the present invention comprises the feature of indicating if more than a predetermined first number of points in said reference fingerprint lacks correspondence in said input fingerprint.

An advantage of this is that an indication is obtained if the number of points is too low to be able to ensure that a sufficient set of data is available for the comparison to be considered reliable.

Another embodiment comprises the step of indicating if more than a predetermined second number of points in said input fingerprint lacks correspondence in said reference fingerprint.

An advantage of this is that an indication is obtained if the number of points is too great to be able to ensure that sufficiently reliable data is available for the comparison to be considered reliable.

Another embodiment comprises the feature of indicating if more than a predetermined third number of points in said reference fingerprint is of a type different from their equivalents in said input fingerprint.

An advantage of comparing types is that this is an invariant property of the point, that is independently of rotation and translation of the fingerprint, the type will be the same.

Another advantage is that a further comparison is made between the points in the input fingerprint and their equivalents in the reference fingerprint.

A further embodiment of the invention further comprises the feature of indicating if more than a predetermined fourth number of points in said input fingerprint is associated with point-specific angles which differ from the point-specific angles that are associated with corresponding points in said reference fingerprint.

An advantage of this embodiment is that the point-specific angles are invariant, which makes them suitable for comparison purposes.

A further advantage of this embodiment is that another comparison is made between the points in the input fingerprint and their equivalents in the reference fingerprint.

According to a second aspect of the invention, a computer program product is provided, comprising instructions for execution in a data-processing unit, wherein the instructions in execution make said data-processing unit perform one of the above-described methods.

According to a third aspect of the invention, a device is provided for aligning an input fingerprint with a reference fingerprint, comprising a receiver adapted to receive an input fingerprint, a determining means adapted to determine a rotational difference by means of a number of reference angles based on said reference fingerprint, in turn comprising identifying a number of points in said input fingerprint, forming groups of said number of points, determining an angle for each said group, forming a number of angle differences by subtracting each of said angles with each of said reference angles, determining a number of occurrences of angle differences in a number of angle ranges and determining a main angle range, and a compensator adapted to compensate for said rotational difference by rotating said input fingerprint at an angle based on said main angle range.

According to a fourth aspect of the invention, a device is provided for identifying or verifying a person's identity, comprising a receiver adapted to receive an input fingerprint, a determining means adapted to determine a rotational difference by means of a number of reference angles based on said reference fingerprint, in turn comprising identifying a number of points in said input fingerprint, forming groups of said number of points, determining an angle for each said group, forming a number of angle differences by subtracting each of said angles with each of said reference angles, determining a number of occurrences of angle differences in a number of angle ranges, and determining a main angle range, a compensator adapted to compensate for said rotational difference by rotating said input fingerprint at an angle based on said main angle range, and a comparator adapted to compare said aligned input fingerprint with said reference fingerprint.

In one embodiment of the above fourth aspect of the invention, said receiver, said determining means, said compensator and said comparator are arranged on a smart card.

According to a fifth aspect of the invention, a system is provided for aligning an input fingerprint with a reference fingerprint, comprising a fingerprint reader, a device and a communication channel between said fingerprint reader and said device, wherein said device is arranged according to the fourth aspect of the invention.

According to a sixth aspect of the invention, a system is provided for identifying or verifying a person's identity, comprising a fingerprint reader, a device and a communication channel between said fingerprint reader and said device, wherein said device is arranged according to the fourth aspect of the invention.

According to a seventh aspect of the invention, a method is provided for aligning an input fingerprint with a reference fingerprint, comprising setting a rotational difference between said input fingerprint and said reference fingerprint to a predetermined rotation value, determining and compensating for a first translational difference in a first direction by means of a number of first reference coordinates based on said reference fingerprint, in turn comprising identifying a number of points in said input fingerprint, forming groups of said number of points, determining a first coordinate for each said group, forming a number of first coordinate differences by subtracting each of said first coordinates with each of said first reference coordinates, determining a first number of occurrences of coordinate differences in a number of first ranges, determining a first main range, and compensating for said first coordinate difference by translating said input fingerprint a distance which is based on said first main range in said first direction.

The advantage of setting the rotational difference to a predetermined value, instead of calculating it according to the first aspect, is that fewer operations have to be executed by the processor.

In one embodiment of this aspect of the invention, the predetermined rotation value is set to zero degrees.

Just like in the first aspect of the invention, an input fingerprint is aligned with a reference fingerprint. The difference is that, in this embodiment, the rotational difference is set to a predetermined value, which means that the above embodiments and aspects based on the first aspect can also be applied to this aspect.

The methods may, according to additional aspects of the invention, be implemented in the form of computer program products, devices or systems, which have been adapted to perform the methods.

Terms such as “first”, “second”, “third” etc should here not be interpreted as time aspects, prioritizing aspects or the like, where this is not specifically stated, but serve only to distinguish different elements, steps, measures, parameters etc.

### BRIEF DESCRIPTION OF THE DRAWINGS

The invention will now be described with reference to the accompanying schematic drawings, which illustrate non-limiting examples of embodiments of the invention.

FIG. 1 is a schematic view of part of a fingerprint, in which a plurality of minutiae points have been identified.

FIG. 2 illustrates schematically the minutiae points in FIG. 1, when extracted from the image.

FIG. 3a is a schematic view of a group consisting of three minutiae points.

FIG. 3b is a schematic view of a group consisting of two minutiae points.

FIG. 4 is a schematic flow chart of a method for forming reference angles and first and second reference coordinates.

FIG. 5a is schematic flow chart of a method for compensating for the rotational difference between an input fingerprint and a reference fingerprint.

FIG. 5b is a schematic flow chart of an alternative method where the rotational difference between an input fingerprint and a reference fingerprint is set to a predetermined value.

FIG. 6 is a schematic flow chart of a method for compensating for a first translational difference between an input rotation-compensated fingerprint and a reference fingerprint.

FIG. 7 is a schematic flow chart of a method for compensating for a second translational difference between an input fingerprint rotation-compensated and translation-compensated in a first direction and a reference fingerprint.

FIG. 8a shows an example of an input fingerprint and a reference fingerprint.

FIG. 8b shows an example of an input rotation-compensated fingerprint and a reference fingerprint.

FIG. 8c shows an example of an input fingerprint rotation-compensated and translation-compensated in a first direction and a reference fingerprint.

FIG. 8d shows an example of an input fingerprint rotation-compensated and translation-compensated in a first and second direction and a reference fingerprint.

FIG. 9 is a schematic flow chart of a method of rotation- and translation-compensating an input fingerprint where probability checks for matching are made between the different compensation steps.

FIG. 10 is a schematic view of a device for alignment and/or comparison of an input fingerprint with a reference fingerprint.

FIG. 11 is a schematic view of a system for aligning and/or comparing an input fingerprint with a reference fingerprint.

### DETAILED DESCRIPTION OF EMBODIMENTS

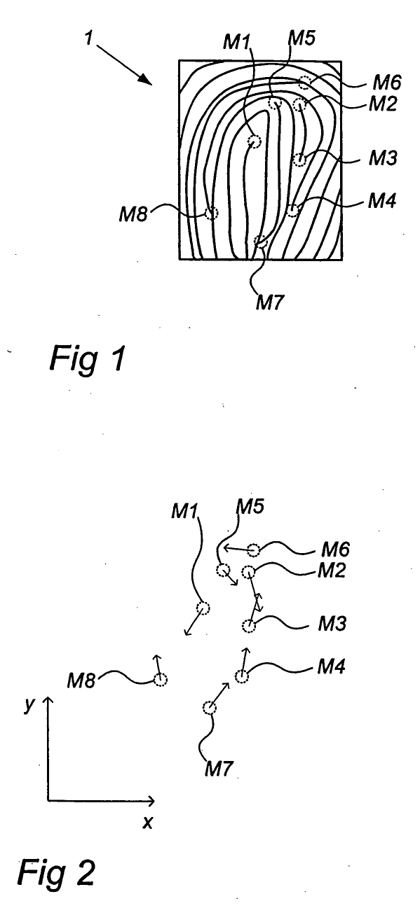

With reference to FIG. 1, part of a fingerprint 1 is shown. In this fingerprint, a number of points, M1-M8, are marked. In this case the points consist of minutiae points. Five of the marked points, M1-M5, are of the type endings while the three remaining points, M6-M8, are of the type bifurcations. For each point, a position, an angle and a type are stored.

The reason why only the positions, angles and types of the points are stored is that the data set for representing a fingerprint can be reduced significantly. FIG. 2 shows the points with associated angles, and thus illustrates the information, except type, that is sent from the reader to the smart card.

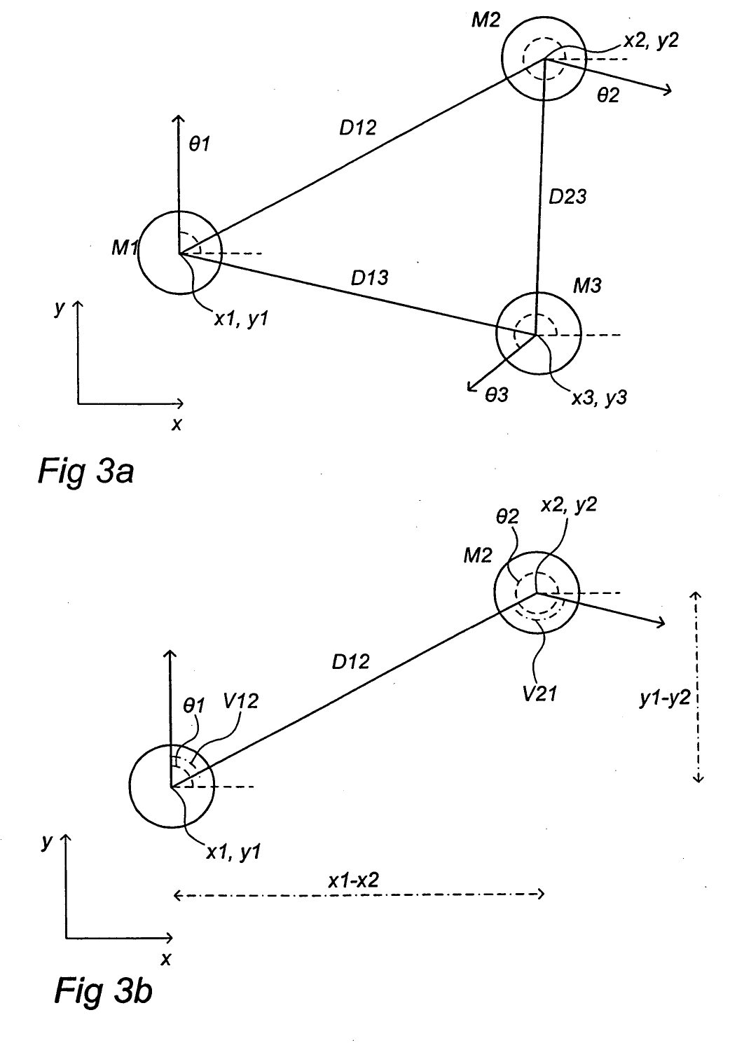

FIG. 3a shows three points M1, M2 and M3. Each point is represented by two coordinates: (x1,y1), (x2,y2) and (x3, y3) respectively, and an angle indicating the direction of the papillary line: θ1, θ2 and θ3 respectively. Also a type of minutiae point can be associated with each point.

FIG. 3b shows two points M1 and M2. To calculate the distance between these two points, the differences between the two coordinates, (x1−x2) and (y1−y2), are calculated and then, based on these two differences, a distance between the two points can be calculated by the Pythagorean theorem.

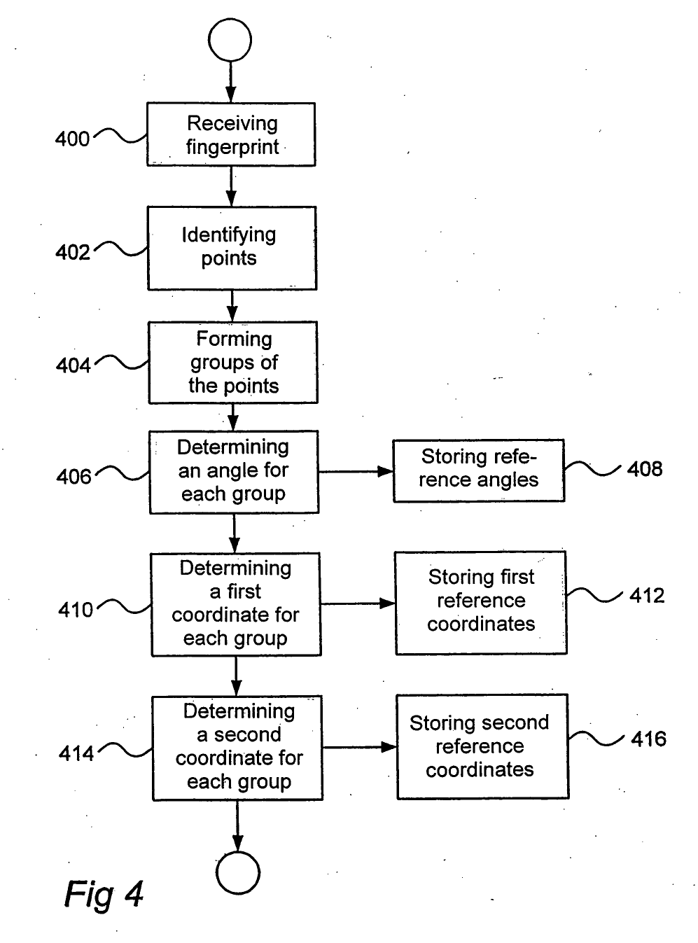

FIG. 4 illustrates a method for inputting a reference fingerprint.

In a first step 400, a fingerprint in raw format is received, for instance as a digital image. This fingerprint in raw format is read by a suitable fingerprint reader (not shown).

In a second step 402, a number of points are identified. These points can be minutiae points, that is bifurcations or endings of papillary lines, but can also be other points in the fingerprint which are assessed to be more characteristic than others.

To obtain these points, it may be necessary to have a preprocessing step. An example of such a preprocessing step is to convert the fingerprint into a two-dimensional frequency spectrum, in which a number of characteristic points are then identified.

Of the points found in step 402, various groups are then formed in step 404. A group need not necessarily consist of two points, and may also consist of three or four points. However, the greater number of points in a group, the more combinations can be formed.

Subsequently, an angle for each group is calculated in step 406. This angle can, if a group consists of two points, be calculated as the angle that is formed by a line extending through the two points and a horizontal line, or alternatively a vertical line. If a group consists of more than two points, a straight indicative line can be calculated by, for example, the “least square” method, and after that it is possible to calculate the angle forming between this straight indicative line and a horizontal line, or alternatively a vertical line.

After being determined, the angles are stored in step 408 as reference angles.

Similarly to the determining of the angles in step 406, also a first coordinate is determined in a first direction in step 410 for each group.

The first coordinates are determined, for example, by calculating an average of the first coordinates of the points included in the group, that is coordinates indicating a position in the first direction.

With the first coordinates determined, they are stored in step 412 as first reference coordinates.

In the same way as the first coordinates were determined in step 410, the second coordinates are determined in a second direction in step 414.

With the second coordinates determined, they are stored in step 416 as second reference coordinates.

Reference angles and first and second reference coordinates are now stored.

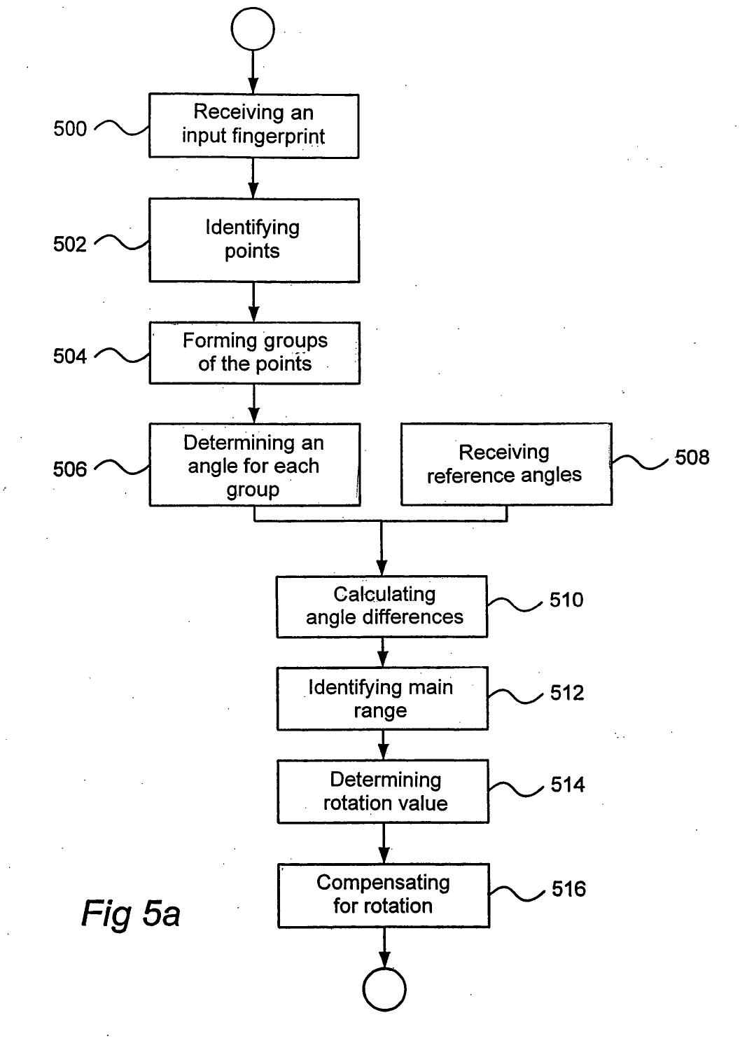

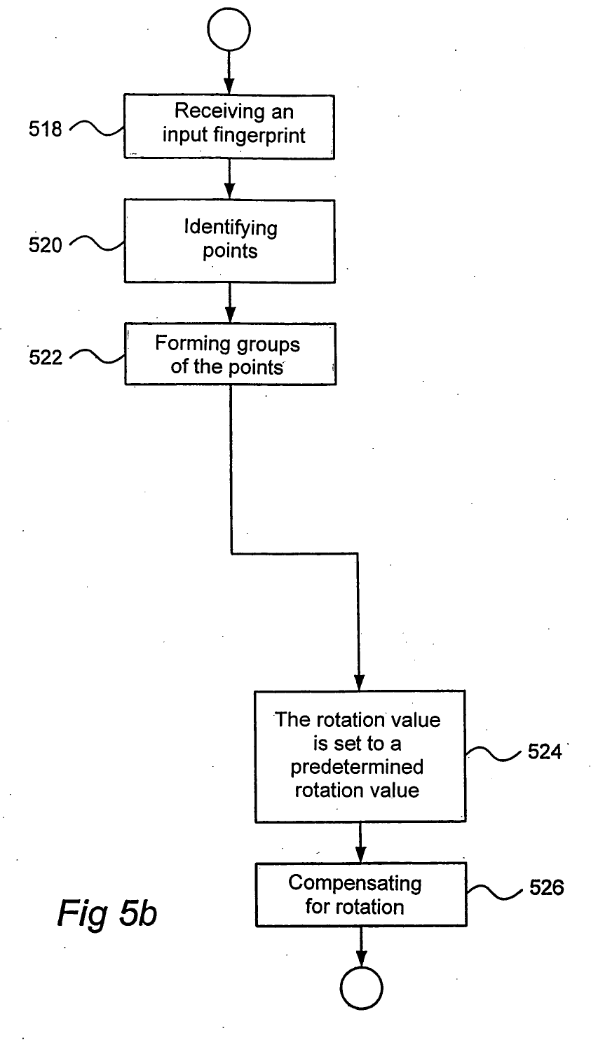

With reference to FIG. 5a, a method is described to compensate for a rotational difference between the reference fingerprint and the input fingerprint.

In a first step 500, the input fingerprint is received. This fingerprint may be read by a fingerprint reader (not shown).

With the fingerprint read, a number of points in the input fingerprint are identified in step 502. The points are selected in the same way as they were selected when creating the reference fingerprint in FIG. 4.

Then groups of the points found are formed in step 504 in the same way as in the forming of the reference fingerprint in step 404. If a group consisted of two points while creating the reference fingerprint, a group should consist of two points also in this step and, correspondingly, if a group consisted of another specific number of points greater than two while creating the reference fingerprint.

In step 506, an angle for each group of points is determined. The angle is determined in the same way as in the creation of reference angles in step 406.

In the next step, step 508, the stored reference angles are retrieved from a storage.

Then, in step 510, differences between each of the determined angles and each of the reference angles are calculated.

With the angle differences calculated, the number of occurrences of angle differences in different angle ranges is determined in step 512. After that a main angle range is determined among these angle ranges. This angle range can be the angle range in which the greatest number of occurrences is found. Another option, for instance if the distribution of occurrences in the different angle ranges is assessed to have a normal distribution, is also to weigh in the number of occurrences in adjacent angle ranges.

With the main angle range identified, a rotation value is calculated in step 514, which can be done by an average for an angle in this main range being calculated.

Then the input fingerprint is rotated in step 516 according to the determined rotation value.

Another alternative is that the reference fingerprint is rotated instead of the input fingerprint.

Another alternative solution is to repeat, with the main angle range identified, the process with narrower angle ranges and only in the main range, thus achieving a narrower range, which in turn implies that the rotation will be more precise.

Since the input fingerprint consists of a number of points with associated angles and types, a rotation of the input fingerprint may seem abstract. What is actually done is that points and their associated angles are multiplied by a rotation matrix selected according to the rotation value, or alternatively by lookup in a table.

If the fingerprint reader is designed in such a manner that the rotational difference is negligible, the rotation value can be set to a predetermined value, for instance zero degrees, according to the alternative embodiment as will be described below with reference to FIG. 5b.

In a first step 518, the input fingerprint is received. This fingerprint can have been read by a fingerprint reader (not shown).

With the fingerprint read, a number of points in the input fingerprint are identified in step 520. The points are selected in the same way as they were selected in the creation of the reference fingerprint in FIG. 4.

Subsequently, groups of the points found are formed in step 522, in the same way as in the creation of the reference fingerprint in step 404. If a group consisted of two points in the creation of the reference fingerprint, a group should consist of two points also in this step and, correspondingly, if a group consisted of another specific number of points greater than two in the creation of the reference fingerprint.

In step 524, the rotation value is set to a predetermined rotation value.

Then the input fingerprint is rotated in step 526 according to the predetermined rotation value, unless the predetermined rotation value is zero degrees.

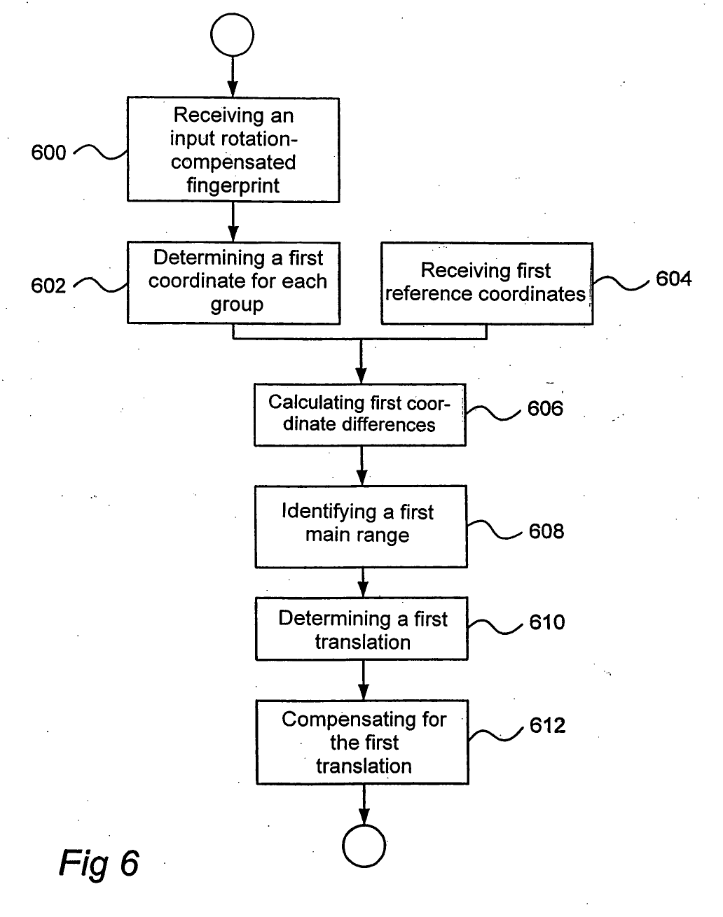

With reference to FIG. 6, a method is described to compensate for the translational difference in a first direction.

In step 600, a rotation-compensated input fingerprint is received.

Then a first coordinate for each group is determined in step 602. This first coordinate is calculated in the same way as described above in step 410.

For instance, in a situation according to FIG. 3b with three points in the input fingerprint, M1, M2 and M3, thus a first coordinate for each group of points is first evaluated. If the first coordinates are calculated as central coordinates, the first coordinates, xc12, xc13 and xc23, are calculated as follows:

$$xc 12 = \frac{1}{2} ( x 1 + x 2 )$$

$$xc 13 = \frac{1}{2} ( x 1 + x 3 )$$

$$xc 23 = \frac{1}{2} ( x 2 + x 3 )$$

wherein x1, x2 and x3 is the coordinate in a first direction, in this example the first direction is the same as the x direction, for the first, second and third points respectively.

After that, first reference coordinates are received in step 604.

In the next step, step 606, first coordinate differences are determined, which means that the first coordinates which have been calculated based on the input int are subtracted with the first reference coordinates which have been calculated based on the reference fingerprint.

For instance, the first coordinates which have been calculated in the example above, xc12, xc13 and xc23, will each be subtracted with the first reference coordinates which have been calculated based on the reference fingerprint xc12r, xc13r and xc23r, as follows:
Δxc1212=xc12−xc12r
Δxc1213=xc12−xc13r
Δxc1223=xc12−xc23r
Δxc1312=xc13−xc12r
Δxc1313=xc13−xc13r
Δxc1323=xc13−xc23r
Δxc2312=xc23−xc12r
Δxc2313=xc23−xc13r
Δxc2323=xc23−xc23r

After determining this number of differences, the number of occurrences in different ranges are calculated.

For example, the above nine differences can be sorted as follows:

| | |
|---|---|
| 0-3 | 2 occurrences |
| 4-6 | 1 occurrence |
| 7-9 | 5 occurrences |
| 10-12 | 1 occurrence |

In the next step, step 608, a first main range is identified. This first main range can be the range in which there are most occurrences, but may also be, for instance, a range which has adjacent ranges with several occurrences as discussed above.

For instance, if the main range is the range with most occurrences, the range 7 to 9 is the main range in the example above.

Then a first translation distance is determined in step 610. This first translation distance can be calculated, for instance, as the average of the previously determined first main range.

Having determined the first translation distance, this first translational difference is compensated for in step 612 by moving the input fingerprint a distance in a first direction that corresponds to this first translation distance.

For example, if the main range is from 7 to 9 and an average of the main range constitutes the first translation distance, the first translation distance will be 8. Then the points, x1, x2 and x3, will be moved 8 steps.

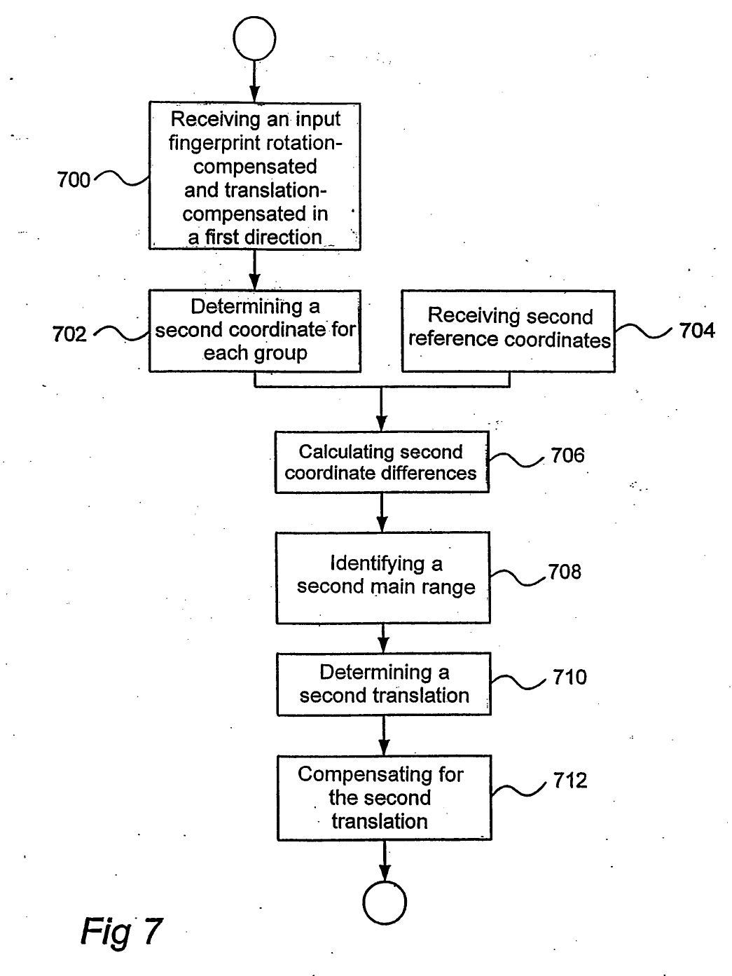

With reference to FIG. 7, a method is described to compensate for the translational difference in a second direction.

In step 700, an input fingerprint which is rotation-compensated and translation-compensated in a first direction is received.

Then a second coordinate for each group is determined in step 702. This second coordinate is calculated in the same way as above in step 414.

For example, in a situation according to FIG. 3b with three points in the input fingerprint, M1, M2 and M3, thus a first coordinate for each group of points is first calculated. If the first coordinates are calculated as central coordinates, the first coordinates, yc12, yc13 and yc23, are calculated as follows:

$$yc 12 = \frac{1}{2} ( y 1 + y 2 )$$

$$yc 13 = \frac{1}{2} ( y 1 + y 3 )$$

$$yc 23 = \frac{1}{2} ( y 2 + y 3 )$$

wherein y1, y2 and y3 is the coordinate in a second direction, in this case the first direction is the same as the y direction, for the first, second and third points respectively.

After that, second reference coordinates are received in step 704.

In the next step, step 706, second coordinate differences are determined, which means that the second coordinates which have been calculated based on the input fingerprint are subtracted with the second reference coordinates which have been calculated based on the reference fingerprint.

For example, the second coordinates which have been calculated above, yc12, yc13 and yc23, will each be subtracted with the second reference coordinates which have been calculated based on the reference fingerprint, yc12r, yc13r and yc23r, as follows:
Δyc1212=yc12−yc12r
Δyc1213=yc12−yc13r
Δyc1223=yc12−yc23r
Δyc1312=yc13−yc12r
Δyc1313=yc13−yc13r
Δyc1323=yc13−yc23r
Δyc2312=yc23−yc12r
Δyc2313=yc23−yc13r
Δyc2323=yc23−yc23r

Having determined this number of differences, the number of occurrences in different ranges are calculated.

For instance, the above nine differences can be sorted as follows:

| | |
|---|---|
| 0-3 | 1 occurrence |
| 4-6 | 8 occurrences |
| 7-9 | 0 occurrence |
| 10-12 | 0 occurrence |

In the next step, step 708, a second main range is identified. The second main range can be the range in which there are most occurrences, but may also be, for instance, a range which has adjacent ranges with several occurrences as discussed above.

For instance, if the main range is the range with most occurrences, the range 4 to 6 is the main range in the example above.

Subsequently, a second translation distance is determined in step 710. This second translation distance can be calculated, for instance, as the average of the previously determined second main range.

Having determined the second translation distance, this second translational difference is determined in step 712 by moving the input fingerprint a distance in a second direction which corresponds to this second translation distance.

For instance, if the main range is from 4 to 6 and an average of the main range constitutes the first translation distance, the second translation distance will be 5. Then the points, y1, y2 and y3, will be moved 5 steps.

The three methods illustrated in FIG. 5, FIG. 6 and FIG. 7 suitably occur in succession, which means that first a rotation compensation occurs, then a translation compensation in a first direction and finally a translation compensation in a second direction.

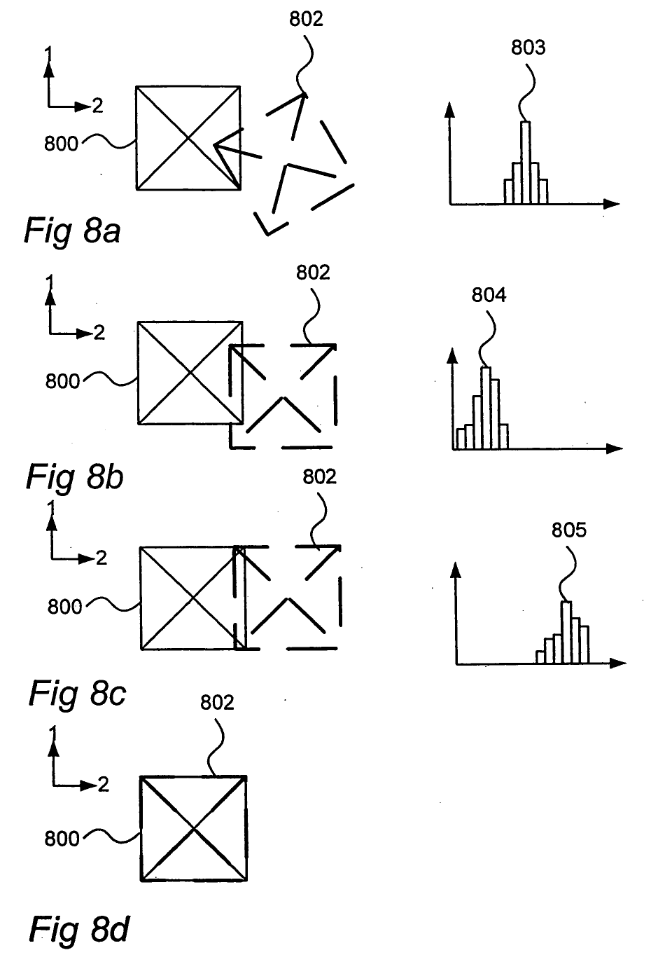

FIG. 8a shows a reference fingerprint 800, which consists of four points, which are connected with dashed lines, and an input fingerprint 802 which also consists of four points, which are connected with solid lines. The Figure also shows two coordinate axes, a first axis indicating a first direction and a second axis indicating a second direction.

The Figure also shows an example of a possible histogram of the number of occurrences with respect to different angle ranges. The main angle range 803 is in this example the angle range in which there are most occurrences.

In FIG. 8b, a compensation of the rotation has been made according to one of the methods described in connection with FIG. 5a. In this example, the input fingerprint 802 is rotated while the reference fingerprint 800 remains constant.

The Figure also shows an example of a possible histogram of the number of occurrences of first translational differences in different ranges. The first main range 804 is in this example the range in which there are most occurrences.

In FIG. 8c, a compensation of the translation in a first direction has been made according to FIG. 6.

The Figure also shows an example of a possible histogram of the number of occurrences of second translational differences in different ranges. The second main range 805 is in this example the range in which there are most occurrences.

In FIG. 8d, a compensation of the translation in a second direction has been made according to FIG. 7.

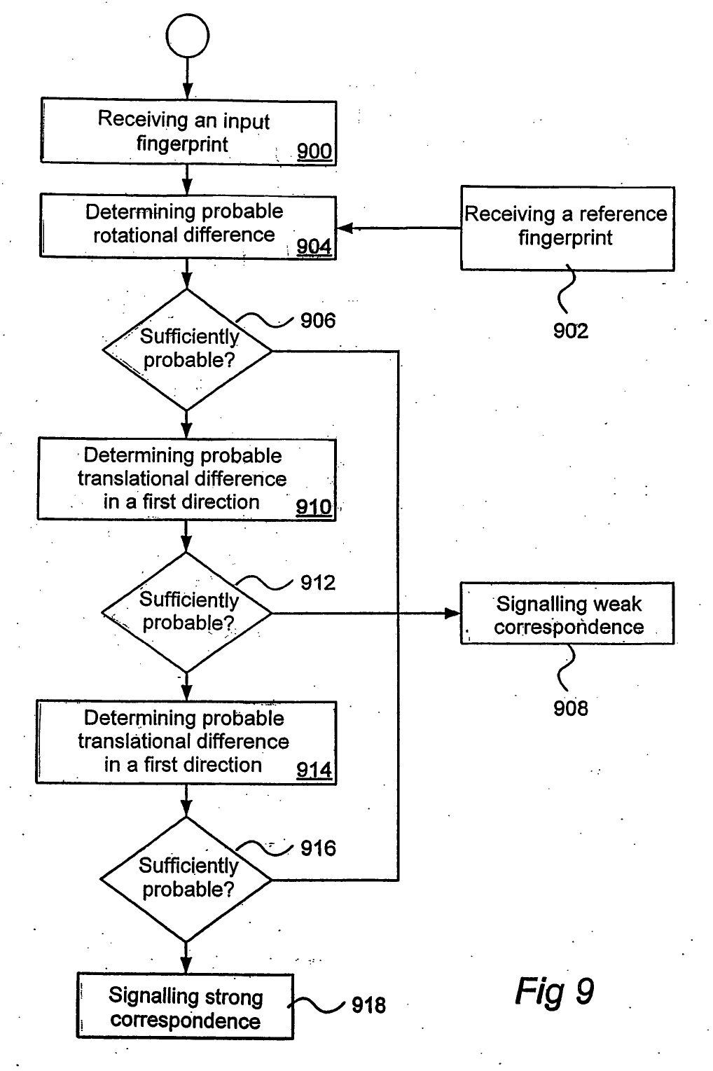

FIG. 9 shows a unified method for rotation and translation compensation with checks between the different steps.

In a first step, step 900, an input fingerprint is received, and in a second step 902 a reference fingerprint is received.

Having received the two fingerprints, the main angle range is determined in step 904 according to the method described with reference to FIG. 5.

The number of occurrences in the main angle range gives, together with the total number of occurrences in all angle ranges, a rough estimate of the probability that the input fingerprint is identical to the reference fingerprint. For instance, this estimate can be done by the number of occurrences in the main angle range being divided by the total number of occurrences in all angle ranges. This first share may then be compared with a first predetermined minimum share. In step 906, a comparison is made whether the calculated share is greater than the predetermined minimum share. If the calculated share is not greater than the predetermined minimum share, this is signaled in step 908. Such signaling may imply that the entire comparison is interrupted, and that the verification or identification will have a negative result.

However, if the calculated share value is greater than the predetermined minimum share, the method proceeds to step 910, where the first main translation range is determined.

With the first main translation range determined, the number of occurrences in this range is calculated. This number of occurrences is then compared in the same way as described above with the total number of occurrences in all first translation ranges in order to obtain a second calculated share, and then this second calculated share is compared in step 912 with a second predetermined minimum share. If the second calculation share is not greater than the second predetermined minimum share value, this is signaled in step 908. This signaling may imply that the entire comparison is interrupted and that the verification or identification will have a negative result.

However, if the second calculated share value is greater than the predetermined second minimum share, the method proceeds to step 914 where the second main translation range is determined.

In the same way as in the above two comparisons, a third calculated share is calculated in step 916, which is then compared with a third predetermined minimum share. If the third calculated share is not greater than the third predetermined minimum share, a weak correspondence is signaled in step 908, whereas if the third calculated share is greater than the third predetermined minimum share, a strong correspondence is signaled in step 918.

A signaling about a strong correspondence in step 912 may imply that the verification or identification will have a positive result, but it may also imply that further comparisons are made. For instance, the types in the points in the input fingerprint and their corresponding points in the reference fingerprint can be compared.

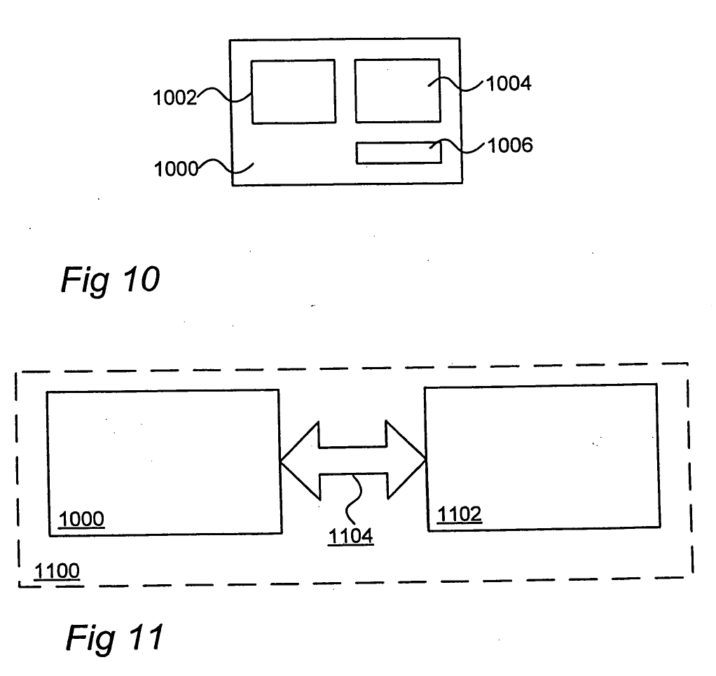

With reference to FIG. 10, a device 1000 is shown for aligning an input fingerprint with a reference fingerprint. The device 1000 comprises a receiver 1002 for receiving the input fingerprint. The input fingerprint is advantageously read by a fingerprint reader and is then transferred either by wire or wirelessly. Moreover the device 1000 comprises a determining means 1004 for determining a rotational difference between the input fingerprint and the reference fingerprint, and a compensator 1006 for compensating for the determined rotational difference.

With reference to FIG. 11, a system 1100 is shown, comprising a device 1000 and a fingerprint reader 1102, the device 1000 and the fingerprint reader 1102 being associated with each other by a communication channel 1104.

What we claim and desire to secure by Letters Patent is:

1. A method of aligning an input fingerprint with a reference fingerprint, comprising
I. determining and compensating for a rotational difference by means of a number of reference angles based on said reference fingerprint and corresponding angles of said input fingerprint.

2. A method as claimed in claim 1, wherein determining and compensating for said rotational difference comprise
Ia. identifying a number of points in said input fingerprint,
Ib. forming groups of said number of points, and
Ic. determining an angle for each said group to constitute an angle of said input fingerprint.

3. A method as claimed in claim 1 or 2, wherein determining and compensating for said rotational difference comprise
Id. forming a number of angle differences by subtracting each of said angles of said input fingerprint with each of said reference angles,
Ie. determining a number of occurrences of angle differences in a number of angle ranges, and
If. determining a main angle range.

4. A method as claimed in claim 3, wherein determining and compensating for said rotational difference further comprise
Ig. compensating for said rotational difference by rotating said input fingerprint at an angle based on said main angle range.

5. A method as claimed in any one of claims 1-4, wherein said main angle range in step If. is the angle range in which the number of occurrences of angle differences between said input fingerprint and said reference fingerprint is greatest.

6. A method as claimed in any one of claims 3-5, wherein said main angle range is only searched in a predetermined angle window.

7. A method as claimed in claim 5 or 6, further comprising
Ih. interrupting the alignment if said number of occurrences in said main angle range is smaller than a first predetermined minimum of occurrences.

8. A method as claimed in any one of claims 1-7, further comprising
Ii. sending a first result signal to a device.

9. A method as claimed in any one of claims 1-8, further comprising
II. determining and compensating for a first translational difference in a first direction by means of a number of first reference coordinates based on said reference fingerprint and corresponding coordinates of said input fingerprint.

10. A method as claimed in claim 9, wherein determining and compensating for a first translational difference comprise
IIa. determining a first coordinate for each group of points in said input fingerprint.

11. A method as claimed in claim 10, wherein determining and compensating for a first translational difference comprise
IIb. forming a number of first coordinate differences by subtracting each of said first coordinates with each of said first reference coordinates,
IIc. determining a first number of occurrences of coordinate differences in a number of first ranges, and
IId. determining a first main range.

12. A method as claimed in claim 11, wherein determining and compensating for a first translational difference further comprise
IIe. compensating for said first coordinate difference by translating said input fingerprint a distance based on said first main range in said first direction.

13. A method as claimed in claim 11 or 12, wherein said first main range in step IId. is the first range in which the number of occurrences of first coordinate differences is greatest.

14. A method as claimed in any one of claims 11-13, wherein said first main range is only searched in a first predetermined translation window.

15. A method as claimed in any one of claims 11-14, further comprising
IIf. interrupting the alignment if said first number of occurrences in said first main range is smaller than a second predetermined minimum of occurrences.

16. A method as claimed in any one of claims 9-15, further comprising
IIg. sending a second result signal to a device.

17. A method as claimed in any one of claims 9-16, further comprising
III. determining and compensating for a second translational difference in a second direction by means of a number of second reference coordinates based on said reference fingerprint and corresponding coordinates of said input fingerprint.

18. A method as claimed in claim 17, wherein determining and compensating for a second translational difference comprise
IIIa. determining a second coordinate for each group of points in said input fingerprint.

19. A method as claimed in claim 16 or 17, wherein determining and compensating for a second translational difference comprise
IIIb. forming a number of second coordinate differences by subtracting each of said second coordinates with each of said second reference coordinates,
IIIc. determining a number of second occurrences of coordinate differences in a second number of ranges, and
IIId. determining a second main range.

20. A method as claimed in claim 19, wherein determining and compensating for a second translational difference comprise
IIIe. compensating for said second coordinate difference by translating said input fingerprint a distance based on said second main range in said second direction.

21. A method as claimed in claim 19 or 20, wherein said second main angle range in step IIId. is the range in which the number of occurrences of second coordinate differences is greatest.

22. A method as claimed in any one of claims 19-21, wherein said second main range is only searched in a second predetermined window.

23. A method as claimed in any one of claims 19-22, further comprising
IIIf. interrupting the alignment if said number of second occurrences in said second main range is smaller than a third predetermined minimum of occurrences.

24. A method as claimed in claim 23, further comprising
IIIg. sending a third result signal to a device.

25. A method as claimed in any one of the preceding claims, wherein said points are minutiae points.

26. A method as claimed in any one of the preceding claims, wherein said group consists of two points.

27. A method as claimed in any one of the preceding claims, wherein only groups are formed of points which are associated with a quality measure which is greater than a predetermined quality threshold.

28. A method as claimed in any one of the preceding claims, wherein only groups are formed of points which are positioned a greater distance from each other than a predetermined minimum distance.

29. A method as claimed in any one of the preceding claims, wherein only groups are formed of points which are positioned a smaller distance from each other than a predetermined maximum distance.

30. A method as claimed in any one of the preceding claims, wherein said determination of number of occurrences comprises calculating a difference between a distance associated with one of said groups in said input fingerprint and a distance associated with one of corresponding groups in said reference fingerprint.

31. A method as claimed in any one of the preceding claims, wherein said determination of number of occurrences comprises calculating a difference between a first angle associated with one of said groups in said input fingerprint and a first angle associated with one of corresponding groups in said reference fingerprint.

32. A method as claimed in any one of the preceding claims, wherein said determination of number of occurrences comprises calculating a difference between a second angle associated with one of said groups in said input fingerprint and a second angle associated with one of corresponding groups in said reference fingerprint.

33. A method as claimed in any one of the preceding claims, wherein said determination of number of occurrences comprises calculating a difference between a type associated with one of said points in said input fingerprint and a type associated with one of corresponding points in said reference fingerprint.

34. A method as claimed in any one of claims 30-33, wherein said number of occurrences is incremented if at least one of said differences is smaller than a difference threshold value.

35. A method as claimed in any one of claims 30-33, wherein said number of occurrences is weighted with respect to at least one of said differences.

36. A method as claimed in any one of the preceding claims, further comprising
forming a number of comparison pairs by matching each said point in said input fingerprint with a corresponding point among said reference points in said reference fingerprint.

37. A method as claimed in claim 36, further comprising
determining a first translational difference for each comparison pair in a first direction,
calculating a first translation value for said first translational differences, and
adjusting said input fingerprint relative to said reference fingerprint in a first direction according to said first translation value.

38. A method as claimed in claim 37, further comprising
determining a first variation measure for said first translational differences,
said adjustment taking place only if said first variation measure is lower than a first predetermined variation threshold.

39. A method as claimed in claim 37 or 38, further comprising
determining a second translational difference for each comparison pair in a second direction,
calculating a second translation value for said second translational differences, and
adjusting said input fingerprint relative to said reference fingerprint in a second direction according to said second translation value.

40. A method as claimed in claim 39, further comprising
determining a second variation measure for said second translational differences,
said adjustment taking place only if said second variation measure is lower than a second predetermined variation threshold.

41. A method of comparing an input fingerprint with a reference fingerprint, comprising
I. forming a number of comparison pairs as claimed in any one of claims 36-40, and
II. comparing said aligned input fingerprint with said reference fingerprint.

42. A method as claimed in claim 41, further comprising
III. indicating if more than a predetermined first number of points in said reference fingerprint lacks correspondence in said input fingerprint.

43. A method as claimed in claim 41 or 42, further comprising
IV. indicating if more than a predetermined second number of points in said input fingerprint lacks correspondence in said reference fingerprint.

44. A method as claimed in any one of claims 41-43, further comprising
V. indicating if more than a predetermined third number of points in said reference fingerprint is of a type different from their equivalents in said input fingerprint.

45. A method as claimed in any one of claims 41-44, further comprising
VI. indicating if more than a predetermined fourth number of points in said input fingerprint is associated with point-specific angles which differ from the point-specific angles that are associated with corresponding points in said reference fingerprint.

46. A computer program product comprising instructions for execution in a data-processing unit,
characterized in that
the instructions in execution make said data-processing unit perform the method as claimed in any one of the preceding claims.

47. A device for aligning an input fingerprint with a reference fingerprint, comprising
a receiver adapted to receive an input fingerprint,
a determining means adapted to determine a rotational difference by means of a number of reference angles based on said reference fingerprint, in turn comprising identifying a number of points in said input fingerprint, forming groups of said number of points, determining an angle for each said group, forming a number of angle differences by subtracting each of said angles with each of said reference angles, determining a number of occurrences of angle differences in a number of angle ranges and determining a main angle range, and
a compensator adapted to compensate for said rotational difference by rotating said input fingerprint at an angle based on said main angle range.

48. A device for identifying or verifying a person's identity, comprising
a receiver adapted to receive an input fingerprint,
a determining means adapted to determine a rotational difference by means of a number of reference angles based on said reference fingerprint, in turn comprising identifying a number of points in said input fingerprint, forming groups of said number of points, determining an angle for each said group, forming a number of angle differences by subtracting each of said angles with each of said reference angles, determining a number of occurrences of angle differences in a number of angle ranges, and determining a main angle range,
a compensator adapted to compensate for said rotational difference by rotating said input fingerprint at an angle based on said main angle range, and
a comparator adapted to compare said aligned input fingerprint with said reference fingerprint.

49. A device as claimed in claim 48, wherein said receiver, said determining means, said compensator and said comparator are arranged on a smart card.

50. A system for aligning an input fingerprint with a reference fingerprint, comprising a fingerprint reader, a device and a communication channel between said fingerprint reader and said device,
characterized in that
said device is arranged according to claim 47.

51. A system for identifying or verifying a person's identity, comprising a fingerprint reader, a device and a communication channel between said fingerprint reader and said device,
characterized in that
said device is arranged according to claim 48 or 49.

52. A method of aligning an input fingerprint with a reference fingerprint, comprising
I. setting a rotational difference between said input fingerprint and said reference fingerprint to a predetermined rotation value,
II. determining and compensating for a first translational difference in a first direction by means of a number of first reference coordinates based on said reference fingerprint, in turn comprising
IIa. identifying a number of points in said input fingerprint,
IIb. forming groups of said number of points,
IIc. determining a first coordinate for each said group,
IId. forming a number of first coordinate differences by subtracting each of said first coordinates with each of said first reference coordinates,
IIe. determining a first number of occurrences of coordinate differences in a number of first ranges,
IIf. determining a first main range, and
IIg. compensating for said first coordinate difference by translating said input fingerprint a distance which is based on said first main range in said first direction.

53. A method as claimed in claim 52, wherein said predetermined rotation value is zero degrees.

54. A method as claimed in claim 52 or 53, wherein said first main range in step IId. is the first range in which the number of occurrences of first coordinate differences is greatest.

55. A method as claimed in claim 54, wherein said first main range is only searched in a first predetermined window.

56. A method as claimed in claim 55, further comprising
IIh. interrupting the alignment if said first number of occurrences in said first main range is smaller than a first predetermined minimum of occurrences.

57. A method as claimed in claim 56, further comprising
IIi. sending a first result signal to a device.

58. A method as claimed in any one of claims 52-57, further comprising
III. determining and compensating for a second translational difference in a second direction by means of a number of second reference coordinates based on said reference fingerprint, in turn comprising
IIIa. determining a second coordinate for each said group,
IIIb. forming a number of second coordinate differences by subtracting each of said second coordinates with each of said second reference coordinates,
IIIc. determining a number of second occurrences of coordinate differences in a second number of ranges,
IIId. determining a second main range, and
IIIe. compensating for said second coordinate difference by translating said input fingerprint a distance based on said second main range in said second direction.

59. A method as claimed in claim 58, wherein said second main angle range in step IIId. is the range in which the number of occurrences of second coordinate differences is greatest.

60. A method as claimed in claim 59, wherein said second main range is only searched in a second predetermined window.

61. A method as claimed in claim 60, further comprising
IIIf. interrupting the alignment if said second number of occurrences in said second main range is smaller than a third predetermined minimum of occurrences.

62. A method as claimed in claim 61, further comprising
IIIg. sending a third result signal to a device.

63. A method as claimed in any one of claims 52-62, wherein said points are minutiae points.

64. A method as claimed in any one of claims 52-63, wherein said group consists of two points.

65. A method as claimed in any one of claims 52-64, wherein only groups are formed of points which are associated with a quality measure which is greater than a predetermined quality threshold.

66. A method as claimed in any one of claims 52-65, wherein only groups are formed of points which are positioned a greater distance from each other than a predetermined minimum distance.

67. A method as claimed in any one of claims 52-66, wherein only groups are formed of points which are positioned a smaller distance from each other than a predetermined maximum distance.

68. A method as claimed in any one of claims 52-67, wherein said determination of number of occurrences comprises calculating a difference between a distance associated with one of said groups in said input fingerprint and a distance associated with one of corresponding groups in said reference fingerprint.

69. A method as claimed in any one of claims 52-68, wherein said determination of number of occurrences comprises calculating a difference between a first angle associated with one of said groups in said input fingerprint and a first angle associated with one of corresponding groups in said reference fingerprint.

70. A method as claimed in any one of claims 52-69, wherein said determination of number of occurrences comprises calculating a difference between a second angle associated with one of said groups in said input fingerprint and a second angle associated with one of corresponding groups in said reference fingerprint.

71. A method as claimed in any one of claims 52-70, wherein said determination of number of occurrences comprises calculating a difference between a type associated with one of said points in said input fingerprint and a type associated with one of corresponding points in said reference fingerprint.

72. A method as claimed in any one of claims 68-71, wherein said number of occurrences is incremented if at least one of said differences is smaller than a difference threshold value.

73. A method as claimed in any one of claims 68-72, wherein said number of occurrences is weighted with respect to at least one of said differences.

74. A method as claimed in any one of claims 52-73, further comprising
forming a number of comparison pairs by matching each said point in said input fingerprint with a corresponding point among said reference points in said reference fingerprint.

75. A method as claimed in claim 74, further comprising determining
a first translational difference for each comparison pair in a first direction,
calculating a first translation value for said first translational differences, and
adjusting said input fingerprint relative to said reference fingerprint in a first direction according to said first translation value.

76. A method as claimed in claim 75, further comprising determining
a first variation measure for said first translational differences,
said adjustment taking place only if said first variation measure is lower than a first predetermined variation threshold.

77. A method as claimed in claim 75 or 76, further comprising
determining a second translational difference for each comparison pair in a second direction,
calculating a second translation value for said second translational differences, and
adjusting said input fingerprint relative to said reference fingerprint in a second direction according to said second translation value.

78. A method as claimed in claim 77, further comprising
determining a second variation measure for said second translational differences,
said adjustment taking place only if said second variation measure is lower than a second predetermined variation threshold.

79. A method of comparing an input fingerprint with a reference fingerprint, comprising
I. forming a number of comparison pairs as claimed in any one of claims 74-78, and
II. comparing said aligned input fingerprint with said reference fingerprint.

80. A method as claimed in claim 79, further comprising
III. indicating if more than a predetermined first number of points in said reference fingerprint lacks correspondence in said input fingerprint.

81. A method as claimed in claim 79 or 80, further comprising
IV. indicating if more than a predetermined second number of points in said input fingerprint lacks correspondence in said reference fingerprint.

82. A method as claimed in any one of claims 79-81, further comprising
V. indicating if more than a predetermined third number of points in said reference fingerprint is of a type different from their equivalents in said input fingerprint.

83. A method as claimed in any one of claims 79-82, further comprising
VI. indicating if more than a predetermined fourth number of points in said input fingerprint is associated with point-specific angles which differ from the point-specific angles that are associated with corresponding points in said reference fingerprint.

84. A computer program product comprising instructions for execution in a data-processing unit,
characterized in that
the instructions in execution make said data-processing unit perform the method as claimed in any one of claims 52-83.

85. A device for aligning an input fingerprint with a reference fingerprint, comprising
a receiver adapted to receive an input fingerprint,
a determining means adapted to set a rotational difference between said input fingerprint and said reference fingerprint to a predetermined rotation value, and determine a first translational difference in a first direction by means of a number of first reference coordinates based on said reference fingerprint, in turn comprising identifying a number of points in said input fingerprint, forming groups of said number of points, determining a first coordinate for each said group, forming a number of first coordinate differences by subtracting each of said first coordinates with each of said first reference coordinates, and determining a first main range, and
a compensator adapted to compensate for said first coordinate difference by translating said input fingerprint a distance based on said first main range in said first direction.

86. A device for identifying or verifying a person's identity, comprising
a receiver adapted to receive an input fingerprint,
a determining means adapted to set a rotational difference between said input fingerprint and said reference fingerprint to a predetermined rotation value, and determine a first translational difference in a first direction by means of a number of first reference coordinates based on said reference fingerprint, in turn comprising identifying a number of points in said input fingerprint, forming groups of said number of points, determining a first coordinate for each said group, forming a number of first coordinate differences by subtracting each of said first coordinates with each of said first reference coordinates, and determining a first main range, and
a compensator adapted to compensate for said first rotational difference by translating said input fingerprint a distance based on said first main range in said first direction, and
a comparator adapted to compare said aligned input fingerprint with said reference fingerprint.

87. A device as claimed in claim 86, wherein said receiver, said determining means, said compensator and said comparator are arranged on a smart card.

88. A system for aligning an input fingerprint with a reference fingerprint, comprising a fingerprint reader, a device and a communication channel between said fingerprint reader and said device,
characterized in that
said device is arranged according to claim 85.

89. A system for identifying or verifying a person's identity, comprising a fingerprint reader, a device and a communication channel between said fingerprint reader and said device,
characterized in that
said device is arranged according to claim 86 or 87.
